(19) United States
(12) Patent Application Publication
(10) Pub. No.: US 2008/0208946 A1
(43) Pub. Date: Aug. 28, 2008

(54) Method Of Data Analysis

(76) Inventors: J. Efrim Boritz, Toronto, CA (US); Fletcher Lu, Scarborough (CA)

Correspondence Address: HODGSON RUSS LLP;THE GUARANTY BUILDING, 140 PEARL STREET, SUITE 100, BUFFALO, NY, 14202-4040, US

(21) Appl. No.: 11/863,696

(22) Filed: Sep. 28, 2007

Related U.S. Application Data
(60) Provisional application No. 60/847,698, filed on Sep. 28, 2006.

(51) Int. Cl. G06F 17/10

(52) U.S. Cl. 708/517

(57) ABSTRACT

A method of analysis of incomplete data sets to detect fraudulent data is disclosed. The method comprises computing constant values for various leading digit sequence lengths, computing artificial Benford frequencies for the digit sequence lengths, computing a standard deviation for each of the sequence lengths, and flagging any digit sequences in the data set that deviate more than an upper bound number of standard deviations from the artificial Benford frequencies, the upper bound used to determine if the observed data deviates enough to be considered anomalous and potentially indicative of fraud or abuse.

### CROSS-REFERENCE TO RELATED APPLICATIONS

This application claims the benefit of U.S. Provisional Application No. 60/847,698, filed Sep. 28, 2006, the disclosure of which is incorporated by reference herein.

### FIELD OF THE INVENTION

This invention relates to an improved method of analysis preferably utilized to detect fraudulent data.

### BACKGROUND OF THE INVENTION

As described in Frank Benford's “The Law of Anomalous Numbers” (Proceedings of the American Philosophical Society, pages 551-571, 1938), for many naturally occurring phenomena, the frequency of occurrences of digits within recorded data follows a certain logarithmic probability distribution (a Benford distribution). Benford's law is known to be based on the general observation that many naturally occurring phenomena grow in a geometric pattern. Based upon this principle, Benford developed a mathematical equation to specify the frequency of how often both individual and sequences of digits may appear within collected data based on such naturally occurring phenomena. In regards to fraud detection, since this law describes naturally occurring phenomena, it may be used to compare digits in test data that should follow a Benford distribution. Any digit sequences that deviate significantly from that specified by a Benford probability distribution would be considered anomalous and indicative of possible fraud activity. Benford's Law is a mathematical formula that specifies the probability of leading digit sequences appearing in a set of data. What we mean by leading digit sequences is best illustrated through an example. Consider the set of data:

S={231, 432, 23, 634, 23, 1, 234, 2, 1, 23, 34, 1232}.

There are twelve data entries in set S. The digit sequence ‘23’ appears as a leading digit sequence (i.e. in the first and second positions) 4 times. Therefore the probability of the first two digits being ‘23’ is 4/9=0.44. The probability is computed out of 9 because only 9 entries have at least 2 digit positions. Entries with less than the number of digits being analysed are not included in the probability computation. The mathematical formula of Benford's Law is:

P(D=d)=log₁₀(1+1/d), (1)

where P (D=d) is the probability of observing the digit sequence d in the first ‘y’ digits and where d is a sequence of ‘y’ digits. For instance, Benford's Law would state that the probability that the first digit in a data set is ‘3’ would be log 10 (1+⅓). Similarly the probability that the first 3 digits of the data set are ‘238’, would be log 10(1+ 1/238). The numbers ‘238’, ‘2382’, and ‘23885’ would all be instances of the first three digits being ‘238’. However, this probability would not include the occurrence ‘3238’, as ‘238’ is not the first three digits in this instance. In order to apply equation 1 as a test for a data set's digit frequencies, Benford's Law requires that:

1. The entries in a data set should record values of similar phenomena. In other words, the recorded data cannot include entries from two different phenomena such as both census population records and dental measurements.

2. There should be no built-in minimum or maximum values in the data set. IN other works, the records for the phenomena must be complete, with no artificial stare value or ending cut-off value.

3. The data set should not be made up of assigned numbers, such as phone numbers.

4. The data set should have more small value entries than large value entries.

Under these conditions, Benford noted that the date for such sets, when placed in ascending order, often follows a geometric growth pattern (Note that the actual data does not have to be recorded in ascending order. This ordering is merely an illustrative tool to understand the intuitive reasoning for Benford's Law). Under such a situation, equation 1 specifies the probability of observing specific leading digit sequences for such a data set. The intuitive reasoning behind the geometric growth of Benford's Law is based on the notion that for low values it takes a great deal of time for some event to grow from ‘1’ to ‘2’. In other words, it must double from ‘1’ to ‘2’. However, increasing from ‘2’ to ‘3’ requires only a growth of 50%. Thus, when recording numerical information at regular intervals, one often observes low digits much more frequently than higher digits, usually decreasing geometrically. This geometric distribution phenomena is common in many areas such as population distributions, purchasing prices, cancer growth, etc. In addition, as this is a geometric growth patter, it should be invariant to the actual counting base.

As noted above, Benford's Law specifies the probability distribution for complete sets of data. One of the requirements to be able to apply Benford's Law is that there are no built-in minimum or maximum values. However, when data is only partially observed, such as when only a single month or even a year of expense reports are filed, this does not necessarily mean that the data does not follow a Benford distribution for its digits. Rather, it only means that we do not have the complete data set. Under such a situation, the user is aware of the limited data being reported. Nonetheless it would still be desirable to apply Benford's Law to digit analysis, if possible, to look for anomalies other than the known missing data.

Known methods of analysis of incomplete data sets using Benford's Law are deficient. For example, if calculating frequency of digits that are observed as a probability in an incomplete set of data, with incomplete data, the frequency of the digits that are observed tend to become inflated. For instance, Benford's Law states that in a data set, a first digit of ‘4’ should occur with probability log 10(1+¼)=0.0969. Suppose with a complete data, out of 100 observations, 4 appeared as a first digit 10 times, which closely approximates the Benford probability. However, if the data set is incomplete with only 50 observations recorded, but all 10 occurrences of first digit 4 are still recorded, then we get a probability of 10/50=0.20, essentially inflating the probability of digits that are observed higher due to the missing digits not being included in the total count when computing the ratio frequency to compare with the traditional Benford's Law probability.

There is a need for an improved method of analysing data, including an improved method of analyzing data from incomplete data sets.

### SUMMARY OF THE INVENTION

In accordance with an aspect of the invention herein there is provided a method to detect problems arising from missing data resulting from analysis of incomplete records and adjust the distribution to take into account the missing data. By doing so, the method herein (also referred to herein as Adaptive Benford Method) allows for anomalies such as those due to fraud and abuse to be more accurately detected than those methods known in the art.

In contrast to typical supervised learning methods which will train on known fraud instances, the herein Adaptive Benford Method models the data to an expected non-fraudulent Benford data pattern and any large anomalies are reported as possible fraud, assuming that a complete data set without fraud activity allows a Benford distribution. (i.e. The complete, non-fraudulent, data set satisfies the Benford Law requirements set out above.)

The Adaptive Benford Method in accordance with an aspect of the invention, (preferably using the Algorithm illustrated in FIG. 1) allows improved analysis of data even when the data is partially incomplete. An example implementation is described below with incomplete health insurance data. In that example, the Adaptive Benford Method of the herein invention reported fewer anomalous digit sequences, avoiding the transient effect due to artificial cutoff start and end points for recorded data, as such, producing a more precise set of anomalous leading digit sequences than traditional Benford analysis. An advantage provided by the Adaptive Benford Method eliminates the requirement that there should be no built-in minimum or maximum values in the data set (i.e. the records for the phenomena must be complete, with no artificial start value or ending cut-off value). Thus, the Adaptive Benford Method of the herein invention expands the areas where Benford's Law may be applied, such as for fraud detection analysis.

In accordance with a further aspect of the invention there is provided an improved fraud detection method using a method known as reinforcement learning combined with Benford's Law to find related anomalous patterns that may be indicative of fraud (also referred to as the Adaptive Fraud Discovery Method). The Adaptive Fraud Discovery Method and Algorithm in accordance with this aspect of this invention expands on previous work by linking together anomalies found by Benford's Law to discover patterns of anomalies which, in essence, build a case for fraud. Such patterns were previously typically discovered manually by human auditors. However, under environments with very larger amounts of data and attributes, manual exploration may be completely unwieldy for such human auditors. This aspect of the invention described herein uses a reinforcement learning system to associate anomalies together for improved analysis.

### BRIEF DESCRIPTION OF THE DRAWINGS

FIG. 1 sets out a preferred Algorithm utilized as part of the Adaptive Benford Method in accordance with an aspect of the invention.

FIG. 2 illustrates an example of building a Benford's Law distribution based on observed data.

FIG. 3 illustrates the resulting Benford probability frequencies for both classical Benford and adaptive Benford using 1990 census data.

FIG. 4 shows an example of using the Adaptive Benford Method of the invention to detect possible fraud.

FIG. 5 shows sample health claims data used in the adaptive fraud discovery method of the invention.

FIG. 6 shows rewards produced by the method of the invention.

FIG. 7 demonstrates transitioning from one claims state to another according to a method of the invention.

### DETAILED DESCRIPTION OF THE INVENTION

### Discussion of Adaptive Benford Method

An example where the Adaptive Benford Method of the herein invention may be used is in the situation where data is contiguously recorded so that the only missing data are due to cutoffs below and/or above some thresholds. In accordance with an aspect of the method of the herein invention, the Adaptive Benford method adjusts its distribution of digit frequencies to account for any missing data cutoffs and produces a threshold cutoff value for various ranges of digits. This aspect of the invention then uses those learned values to analyze test data. We return any digits exceeding a learned set of threshold bounds.

In accordance with an aspect of the invention, assuming the condition that we are aware that the observed data follows a Benford distribution and is contiguous, (and preferably if we are missing data only above or below an observed data cutoff), we can use the Adaptive Benford method to artificially build the missing data as follows:

First let

d be a leading digit sequence of length i, 1

f_{d1 observed} be the frequency that leading digit sequence d occurs in the data set, and

P(Dᵢ) be the Benford probability for digit sequence Dᵢ, where Dᵢ is any digit sequence of length i.

Now, consider that to compare the actual frequency of occurrence of a leading digit sequence ‘d’ to the actual Benford probability we would compute the ratio:

$$\frac{{f}_{d , observed}}{{\sum }_{{D}_{i}} {f}_{{D}_{i} , observed}} ≃ P ( {D}_{i} = d ) , \qquad ( 4 )$$

where the denominator is summed over all digit sequences of the same length as digit sequence ‘d’, in other words over all digits of length i. Let Cᵢ=Σ_{D}_{ᵢ}f_{D}_{ᵢ},observed

Then equation 4 can be rearranged to

$$\frac{{f}_{d , observed}}{P ( {D}_{i} = d )} ≃ {\sum }_{{D}_{i}} {f}_{{D}_{i} , observed} = {C}_{i} . \qquad ( 5 )$$

From equation 5 we can see that Cᵢ is essentially a constant scaling factor for all digit sequences of the same length i. Even if there are missing digit sequences in our observed data due to cutoff thresholds, we can still compute Cᵢ using the observed digit sequences, since those sequences that do still appear should still follow the Benford's Law probabilities.

In order to produce a best fit for the missing data, we average over all possible Cᵢ values for a given digit sequence length i. Therefore, let

$${C}_{i} = \frac{{\sum }_{{D}_{i}} {f}_{{D}_{i} , observed} / P ( {D}_{i} )}{\vert digit sequences of length i \vert} . \qquad ( 6 )$$

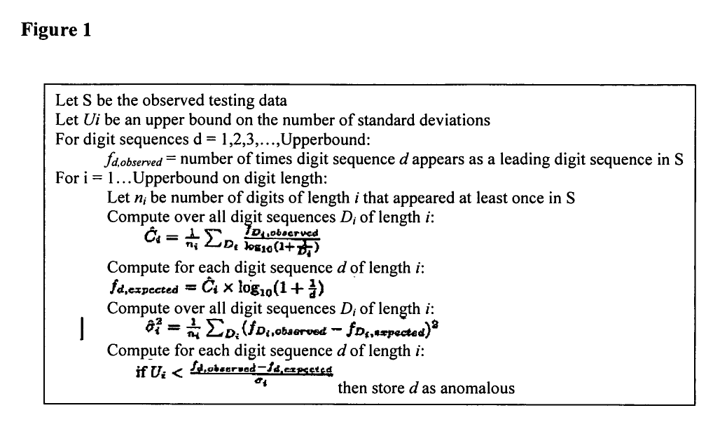

FIG. 1 sets out a preferred Algorithm utilized as part of the Adaptive Benford Method in accordance with an aspect of the invention.

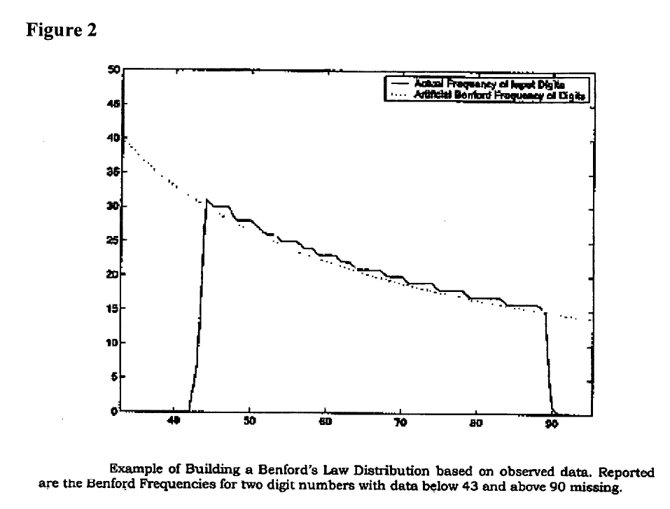

FIG. 2 illustrates an example of the frequency of the observed digits for the first two leading digit frequencies whereby digits both below 43 and above 90 are missing. It also illustrates the artificially created Benford frequency based on the observed data. The artificially created Benford sequence closely approximates the observed frequencies, as expected.

In accordance with an aspect of the invention, the Adaptive Benford Method of data analysis comprises the following steps:

1. Computing the Cᵢ constant values for various leading digit sequence lengths;

2. computing artificial Benford frequencies for the digit sequence lengths;

3. Computing a standard deviation for each of the sequence lengths;

4. Flagging any digit sequences in the recorded data that deviate more than an upper bound number of standard deviations from the artificial Benford frequencies; Wherein artificial Benford frequencies are computed as follows:

fdᵢ,expected=Ci×log 10(1+1d), (7)

where d is a digit sequence, and i is the length of the sequence. Once the fd₁expected is obtained, we may use it to compute a variance against observed data by:

$${σ}_{expected , i}^{2} = \frac{1}{{n}_{i}} {\sum }_{{D}_{i}} {( {f}_{{D}_{i} , observed} - {f}_{{D}_{i} , expected} )}^{2} , \qquad ( 8 )$$

where nᵢ is the number of different digit sequences of size i. An upper bound Uᵢ is computed based on a number of standard deviations from the artificial Benford frequencies. IN example test cases a 95% upper bound confidence interval was used (Other such intervals may be utilized as desired). This upper bound is used to determine if the observed data deviates enough to be considered anomalous and potentially indicative of fraud or abuse.

In this method, we are scaling up to actual frequencies to compare with those actually observed. This is in contrast to simply dividing by a sum total of observed instances which would produce probabilities, which would tend to cause the inflating data effect. Thus, applying this method in accordance with an aspect of the invention avoids the inflating data effect.

Example Applications of the Adaptive Benford Method of Data analysis

For the purposes of example experiments, the first 3 leading digit sequences were analyzed up. The choice of digit sequence lengths to be analysed is dependent on the data set's'entries (the digit lengths of the data set's elements as well as the number of elements in the data set).

### Census Data Tests

TABLE 1
Census Data: Percentage of Digits within ± two standard deviations of
Benford and Adaptive Benford distributions.

| | | Classic | Adaptive |
|---|---|---|---|
| Range of Values | Data Size | Benford | Benford |
| Complete Census | 3141 | 96.2% | 94.9% |
| 100,000-1,100,000 | 431 | 85.0% | 89.4% |
| 200,000-1,200,000 | 220 | 85.6% | 96.9% |
| 300,000-1,300,000 | 144 | 49.5% | 94.4% |
| 400,000-1,400,000 | 106 | 30.8% | 91.7% |
| 500,000-1,500,000 | 84 | 32.0% | 87.2% |
| 600,000-1,600,000 | 65 | 34.0% | 84.0% |
| 700,000-1,700,000 | 48 | 33.8% | 82.4% |
| 800,000-1,800,000 | 36 | 19.2% | 82.7% |
| 900,000-1,900,000 | 24 | 11.8% | 73.5% |

For succinctness, in our graphical results, we report all digit sequence frequencies across a single x-axis of our graphed results. The first digit frequencies are reported on the x-axis from 1 to 9. The first two digit sequence frequencies are reported on the x-axis from 10 to 99. The first three digit sequence frequencies are reported on the x-axis from 100 to 999. Since these are essentially three different cases, the Benford Law artificial frequency estimates will be smooth curves except at the point of change between each pair of cases. In other words, there will be discontinuity points between point 9 to 10 and 99 to 100.

As an initial test of our system we use as a test database the year 1990 population census data for municipalities in the United States which has been analysed previously by Mark J. Nigrini in Digital Analysis Using Benford's Law (Global Audit Publications, Vancouver, B.C., Canada, 2000) and been verified to follow a Benford Law distribution.

Table 1 records the amount of conformity for complete and incomplete census data whereby we measure conformity as the percentage of digit sequences that fall within ±2 standard deviations of the Benford estimate value out of the total number of digit sequences that had non-zero frequency. The two standard deviations should cover approximately 95% of the digit sequences if the data conforms to Benford's distributions. The standard deviation used for all test of table I are computed using the complete 1990 census data. We modified the 1990 census data to include sets of various population ranges of municipalities. The data ranges were specifically chose to demonstrate the effect of reducing leading digit sequences. Notice that for the range 100,00-1,100,000 all leading digit sequences may start with any of 1, 2, . . . , 9. However, for the range 900,000-1,900,00, the only possible leading digits start with 9 or 1. With fewer possible leading digit sequences, the inflating data effect referred to above becomes more likely, resulting in lower conformity as the population range shifts higher. Indeed, due to the cutoff value ranges, census ranges of 300,000-1,300,000 to 900,000-1,900,000 all have less than 50% conformity for Classic Benford.

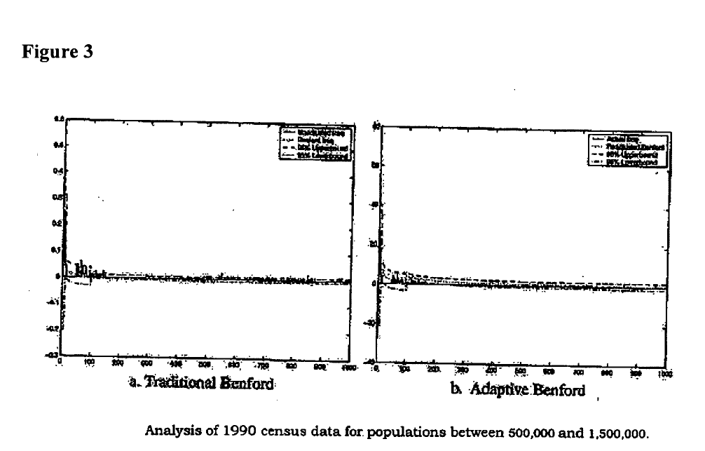

With the Adaptive Benford, which compensates for cutoff data, conformity ranges from 73.5% to 96.9%. FIG. 3 illustrates one data set range (50,000 to 150,000) and the resulting Benford probability frequencies for both classical Benford and adaptive Benford. We also plotted the 95% confidence interval upper and lower bound for the Benford distributions. The classic Benford distributions demonstrate the inflating commented on in section 3.1. Traditional Benford stretches the values producing many more digits exceeding our upper bound tolerance. Our Adaptive Benford Method, in contrast, has only one digit sequence exceeding the 95% upper bound.

### Health Insurance Data Test

Also analyzed were health insurance claims data covering general health, dental and drug claims for financial reimbursement to Manulife Financial covering a single company's group benefits plan for its employees. The data provided covered a three year period from 2003 to 2005. Since the database only reports data from 2003 to 2005 rather than all data from the start of this company's insurance coverage, there is an artificial minimum start point, which will cause problems for traditional Benford, which our Adaptive Benford approach should be able to compensate for. The goal is to detect anomalies in our data sets that may be indicative of fraud activity. Because tradition Benford results in ‘inflated’ percentages when data is missing, we would expect that higher percentages of anomalous digit sequences are reported by traditional Benford in contrast to our adaptive Benford.

Table 2 reports the percentage of anomalous digit sequences for the insurance database for various data sets. As expected, by handling missing data ranges due to cutoff levels, the Adaptive Benford method is shown to be more precise, reporting fewer actual anomalous digit sequences than traditional Benford. In the example shown, a 95% upper bound confidence interval as our anomaly threshold was used.

| Data | | Data | Classic | Adaptive |
|---|---|---|---|---|
| Set | Description | Size | Benford | Benford |
| 1 | Misc. Dental Charges | 589 | 21.05% | 11.48% |
| 2 | Expenses Submitted by | 31,693 | 3.77% | 3.44% |
| 3 | Submitted Drug Costs | 6,149 | 16.80% | 10.40% |
| 4 | Submitted Dispensing Fee | 7,644 | 18.18% | 9.09% |
| 5 | Excluded Expenses | 1,167 | 10.39% | 5.19% |
| 6 | Expenses after deductibles | 29,215 | 3.65% | 13.13% |
| 7 | Coinsurance reductions | 3,871 | 8.85% | 6.19% |
| 8 | Benefit Coordination | 268 | 29.29% | 6.06% |
| 9 | Net Amount Reimbursed | 28,132 | 4.40% | 3.70% |

As is seen above, an advantage of our Adaptive Benford method over traditional Benford for fraud detection is its improved precision for detecting anomalies. The goal, once anomalous digit sequences have been identified, is then to determine the data entries that are causing the high amounts of anomalous digit sequences. A forensic auditor may then, for instance, decide whether these entries are likely fraudulent or abusive charges. Making such decisions is often a qualitative judgement call dependent often on factors related to the specific application area. We therefore have avoided here labeling our reported anomalies as actual fraud. Instead, we emphasize that these digit sequence anomalies are to be used as a tool to indicate possible fraud.

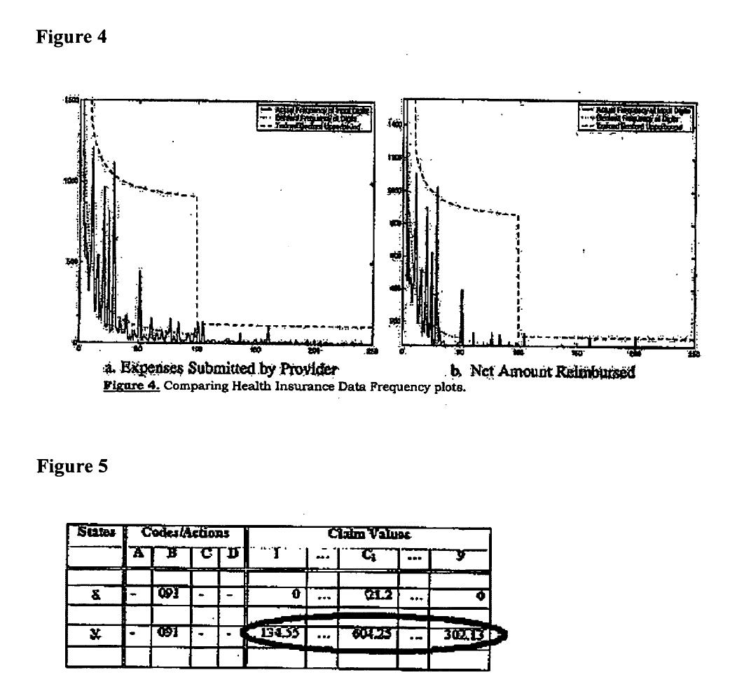

As an example of using the Adaptive Benford Method of the herein invention to detect possible fraud, consider FIG. 4. FIG. 4 illustrates two frequency data set plots for data set 1, the ‘Expenses Submitted by Provider’, and data set 2, the ‘Net Amount Reimbursed’. The submitted values have digits that exceed learned upper threshold bounds at digits 2, 29, 101 and 105. The actual reimbursed claims have digits that exceeded learned upper threshold bounds at digits 2, 29, 105 and 200. Looking closely at the data, we can see that there is a great deal of fluctuation for both graphs in the lower digits. A closer analysis of this data reveals that this often corresponds to fixed procedures such as dental checkup values that are frequently expensed. With this digital analysis, a forensic auditor may use this to search for abuse in the system. For instance, the high use of a $29 procedure which exceeds our threshold tolerance level, may be an indication of abuse whereby the low cost value may be considered by an abuser as a charge that is easy to avoid notice by large insurance companies. Because the high $29 digit sequence appears in both the submitted and actual reimbursed plots, we can infer that if the charge is fraudulent, it is not being detected since it is actually being reimbursed as the data set 2 plot indicates. This is one example of using the Adaptive Benford anomalies to detect possible fraud. However, as a precaution, consider that the high frequency of the $29 dental charge may also be an indication of a health problem plaguing the employees of the company whose data this is drawn from and not actual fraudulent activity.

### Discussion of Adaptive Fraud Discovery Algorithm

A further aspect of the invention is directed to an Adaptive Fraud Discovery algorithm method, which is designed to go one step beyond the traditional Benford's Law technique of fraud discovery. Instead of only finding phenomena that are meant to follow a Benford distribution and then flagging anomalies that an auditor then investigates, this aspect of the invention attempts to perform some of the investigating that an auditor would traditionally perform. In this case, our system attempts to link related anomalies together to build a case for fraud.

In accordance with this further aspect of the invention the method of detecting fraud using the adaptive fraud discovery method comprises the following steps:

1. Determine data sets that fit well to a Benford distribution (Benford data sets) wherein each data entry in the Benford data sets represent a single state in a reinforcement learning network;

2. Rewards are assigned to each state by the magnitude that each entry deviates from the expected Benford distribution;

3. Actions are any attributes associated with a state and choosing an attribute picks a particular expression of that attribute.

4. The database is searched for other states with the same attribute expression; and any matching states are potential next states in the reinforcement learning network;

5. A policy improvement/evaluation algorithm is then executed to find an optimal policy.

This algorithm has been written in such a fashion as to be applicable to any application area where fraud discovery is a desired goal.

The standard reinforcement learning environment involves a discrete time Markov reward process on a finite set of N states, n=1, . . . , N is described by a transition model P(Sᵢ₊₁=m|Sᵢ=n), where we assume the transition probabilities do not change over process time I (stationarity assumption). Such a transition model can be represented by an N×N matrix P, where P(n, m) denotes P(Sᵢ₊₁=m|Sᵢ=n) for all process times i. The reward Rᵢ observed at time i is independent of all other rewards and states given the state Sᵢ visited at time i. Assuming the reward model is stationary, let r(n) denote E[Rᵢ|Sᵢ=n] and σ(n) denote Var(Rᵢ|Sᵢ=n) for all process times i. Thus, r and σ represent the vectors (of size N×1) of expected rewards and reward variances respectively over the different states n=1, . . . , N.

The value function ν(n) is defined to be the expected sum of discounted future rewards obtained by starting in a state S₀=n. That is, ν is a vector given by

$$\begin{matrix}\begin{matrix}v = r + γ Pr + {γ}^{2} {P}^{2} r + … \\ = r + γ Pr\end{matrix} & ( 2 )\end{matrix}$$

Therefore, if P and r are known then ν can be calculated explicitly by solving the matrix equation

(1−γP)ν=r (3)

To produce our value estimates we will use sampling trajectories. Several estimators can be applied for the value estimation problem in Markov reward processes. These methods all attempt to estimate the value of each state by processing sampled trajectories. The most common approaches are TD( ) and maximum likelihood.

### Example Application of the Adaptive Fraud Discovery Method

In order to explain and illustrate the details of the implementation of this adaptive fraud discovery method, the following describes as a concrete example a health insurance implementation of said aspect. FIG. 5 illustrates the general format of our insurance data. We were given a flat file of data in tabular format consisting of claims information processed by an insurance company for reimbursement. The table consisted of 94 columns with 31,804 rows. Each row represents a single claim for reimbursement. The columns represent various attributes of the claim, such as the health provider involved with the claim, the province/state within which the claim was made, procedure performed, initial value of claim, etc.

In the first step, we check each column of numerical data for conformity to Benford. AS noted by Mark J. Nigrini in “Digital Analysis Using Benford's Law” (Global Audit Publications, Vancouver, B.C., Canada, 2000), there is no single model for measuring conformity to Benford's Law. In our case, we will use the Z-statistic suggested by Nigrini and commonly used by many auditors:

$$Z = \frac{\vert {p}_{observed} - {p}_{expected} \vert}{\sqrt{{p}_{expected} ( 1 - {p}_{expected} ) / n}} , \qquad ( 9 )$$

where pobserved is the observed proportion of digits, pexpected is the expected proportion of digits and n is the number of observations. For our purposes, if more than 10% of our data in a data set have digit sequences which result in Z>1.64, we do not include it as a Benford distribution set (Alternative goodness-of-fit tests such as the Kolmogorov-Smirnoff test, the chi-square test and the Mean Absolute Deviation have also been suggested as conformity tests for a Benford distribution).

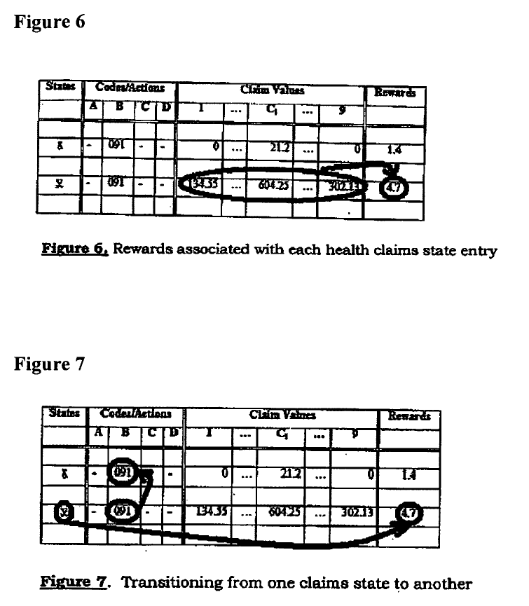

In the health insurance implementation, each row/claim represents a single state in our reinforcement learning network. Benford's Law allows for the analysis of any number of leading digit sequences. For our health application we analyze only the first 3 leading digits, as most of our Benford data have 3 or fewer digit sequences, not including decimal values. This resulted in 5 columns of our database being identified as conforming to a Benford distribution. Rewards, R(s), for each state, s, are computed as a sum of the relative deviations from expected values:

$$R ( s ) = {\sum }_{cv} {\sum }_{seq} \frac{\vert {p}_{observed} - {p}_{expected} \vert}{{p}_{expected}} , \qquad ( 10 )$$

where we sum over the three leading digit sequences (seq) as well as over the 5 different claim value (cv) types that were identified as following a Benford distribution. This produces a single reward value for each row as illustrated in FIG. 6.

The remaining columns that were not identified as following Benford distributions are used as possible action choices in our reinforcement learning explorations. As an example, some of the ‘actions’ which we could choose were a ‘Family Policy ID’ or a ‘Health Provider ID’. Once an action is chose, such as the ‘Family Policy ID’, we search the database down that column for matching ‘Family Policy ID’s. With uniform probability we choose any other state that has a matching ‘Family Policy ID’. In that manner we move from one state to the next as illustrated in FIG. 7. (Our ‘action’ in FIG. 7 is to choose column ‘B’ and find a state with a matching ‘91’ in its ‘B’ column.) For our health insurance application, the reinforcement learning network has no natural start or end states. We used a uniform random selector to choose a start state. Any value estimation method may be used. For our application we used a temporal differencing approach with eligibility traces.

While the invention has been described according to what are presently considered to be the most practical and preferred embodiments, it must be understood that the invention is not limited to the disclosed embodiments. Those ordinarily skilled in the art will understand that various modifications and equivalent structures and functions may be made without departing from the spirit and scope of the invention. Therefore, the invention must be accorded the broadest possible interpretation so as to encompass all such modifications and equivalent structures and functions.

What is claimed is:

1. An improved method of analysis of incomplete data sets to detect fraudulent data comprising the following steps:
computing constant values for various leading digit sequence lengths;
computing artificial Benford frequencies for the digit sequence lengths;
computing a standard deviation for each of the sequence lengths;
flagging any digit sequences in the data set that deviate more than an upper bound number of standard deviations from the artificial Benford frequencies, the upper bound used to determine if the observed data deviates enough to be considered anomalous and potentially indicative of fraud or abuse.
